(19) United States
(12) Patent Application Publication
(10) Pub. No.: US 2019/0176366 A1
(43) Pub. Date: Jun. 13, 2019

(54) DEVICE FOR PROTECTING AN ATTACHMENT INSERT DURING THE OVERMOULDING OF SAME

(71) Applicants: Compagnie Plastic Omnium, Lyon (FR); BOLLHOFF OTALU S.A, LA RAVOIRE (FR)

(72) Inventors: David TRESSE, Saint-Andre de Corey (FR); Emmanuelle BERLIRE, Challes Les Eaux (FR); Sylvain FAGUER, Arbin (FR); Raphael BASSET, Sonnaz (FR); Patrick LEJARS, Barraux (FR)

(73) Assignee: Compagnie Plastic Omnium, Lyon (FR)

(21) Appl. No.: 16/308,556

(22) PCT Filed: Jun. 9, 2017
(86) PCT No.: PCT/FR2017/051461

§ 371 Date: Dec. 10, 2018

(30) Foreign Application Priority Data
Jun. 9, 2016 (FR) FR1655292

(51) Int. Cl. B29C 33/00; B29C 43/18; B29C 45/14

(52) U.S. Cl. CPC B29C 33/0044; B29L 2031/30; B29C 45/14836; B29C 43/18

(57) ABSTRACT

Device for protecting a fastening insert to overmould the fastening insert with a plastic material using a mould, the fastening insert having a fastening member, characterised in that wherein the device comprises:
piercing means adapted to pierce at least one sheet of plastic material;
means for sealing the fastening member to prevent infiltration of plastic material on the fastening member during an overmoulding operation.

This invention relates to the technical field of manufacturing motor vehicle parts made of plastic material, and in particular the field of overmoulding fastening inserts for automotive parts.

In the automotive industry, it is known to manufacture and to use parts having a metal insert and a plastic part overmoulded on the metal insert. It is also known to use plastic inserts during overmoulding.

The use of structural fasteners is necessary in particular for the structural parts: the fasteners used to attach seats to a floor or the seatbelt guide to a B pillar, for example. The manufacture of such parts has emerged as a solution to meet the generally conflicting requirements regarding the properties of the structural element, for example the requirements of lightness and mechanical strength, especially resistance to shocks.

Consequently, to manufacture such structural parts made of plastic material, functionalisation solutions are required, especially to assemble them securely either to each other or to the vehicle. Thus, it is known to use inserts, for example made of metal, comprising fastening means such as a thread (screw and/or tapped hole).

To produce a plastic part, it is known to use a moulding method such as compression and/or injection moulding.

In the case of moulding by hot compression under pressure of a thermosetting plastic material, the method is generally carried out in a mould by displacing a moving element of the mould (moved by a press) relative to a fixed element of the mould, these elements typically being made of steel.

Generally, a loading plane consisting of sheets of plastic material, typically a sheet moulding compound (SMC), is placed in a compression mould. The press is then actuated to close the mould. Actuation of the press then continues to transmit a moulding pressure to the plastic material. The mould is said to be in packing phase. The plastic material can then flow and take the shape of the mould cavity. Lastly, during a “curing” phase, the plastic material polymerises to form a finished part.

To integrate fastening inserts in a part moulded in this way, it is known to add them after moulding the part by one or more rework operations, consisting firstly in creating a housing for them, usually a hole through the thickness of the part, and produced by machining, drilling, punching, before placing the insert in this housing and fastening it by bonding, riveting, crimping or screwing.

This Fastening Method is Restricting for the Following Reasons:
cost of the rework operations performed. This method in fact requires different tools, additional equipment, additional durations for each operation and therefore a longer overall cycle time per part, and resulting in a loss of material when producing the housings.
hygiene, health and maintenance of the equipment due to the dust produced.
mechanical strength due to the residual assembly clearances between the insert and the part.

Furthermore, it is known that an element added during rework after moulding exhibits positioning faults relative to the shapes of the part obtained by moulding.

There is in fact a loss of the “geometrical reference frame” since the part is taken out of the mould without the insert, then placed on a support to successively produce the housings then add the inserts. The inaccuracy of the relative positions of the inserts with respect to each other and with respect to the part makes it more difficult to assemble the part with another component or on the vehicle: for example separation distance or perpendicularity faults can prevent this assembly on vehicle.

As a variant, it is also known to integrate fastening inserts in a part when overmoulding the part, and in this case the fastening member must be protected from this insert to prevent the plastic material from covering this member, even partially. Thus, this fastening member, in particular when using a thread, can no longer be used to fasten an element to the part in which the insert is overmoulded if this thread is partially covered by plastic material loaded with reinforcement elements.

A mould system is also known from patent application FR3024386, for the positioning and accurate holding of an insert in the cavity of this mould, using a disengageable pin.

This solution involves manufacturing moulds integrating additional and complex mechanisms which are therefore more difficult to manufacture and maintain.

The invention aims to remedy these disadvantages by providing a device for protecting a fastening insert, easy to manufacture and easy to use, to overmould the fastening insert with a plastic material using a mould, the fastening insert having a fastening member.

This device comprises piercing means adapted to pierce at least one sheet of plastic material (thermosetting or thermoplastic), and means for sealing the fastening member to prevent infiltration of material on the fastening member during an overmoulding operation.

With such a protective device, it is no longer necessary to manufacture specific moulds, which are difficult to manufacture and maintain, such as moulds with movable pins.

Another advantage, stemming from the previous one, is that it is possible to make attachment points that are very close together, which is not the case with sophisticated mechanisms based on pins whose size in the mould prevents the fasteners from being placed close to each other.

Lastly, the fact of crossing the sheet of plastic material with the piercing means before shaping the material by moulding allows the material to be distributed uniformly around the fastening member, thereby limiting the join lines, and therefore improving the mechanical performance of the part comprising the fastening insert.

The device may further comprise one or more of the following characteristics, taken alone or in combination:
the device forms a shaft comprising first and second ends opposite each other, the first end being provided with the piercing means, and the second end being provided with at least one portion of the sealing means;
the piercing means has a tapered shape and/or edges;
the sealing means forms a plug;
the sealing means is adapted to be tightly assembled on an insert according to one of the preceding claims, wherein the sealing means comprises shapes creating a barrier to the passage of the plastic material MP;
the fastening member is a thread;
the sealing means comprises a thread cooperating with the thread of the insert.

The invention also relates to an assembly of an insert and a device according to the invention, wherein the insert comprises a tapped hole having a thread and forming a female element, and the sealing means comprises a male element adapted to cooperate with the female element in order to sealably plug the tapped hole.

The invention also relates to an assembly of an insert and a device according to the invention, wherein the insert comprises a screw having a thread and forming a male element, and the sealing means comprises a female element adapted to cooperate with the male element in order to sealably cover the screw.

According to the invention, the sealing means is preferably tightly assembled on the insert.

The invention also relates to an assembly of a mould and a device according to the invention, wherein the mould comprises a housing adapted to receive a portion of the device comprising at least the piercing means.

According to the invention, the dimensions of the housing are advantageously defined so that when the mould is closed, a portion of the mould presses on the device so as to press the device tightly on the insert and so as to crush the device in order to fill the housing to prevent an infiltration of plastic material in the housing.

According to the invention, the mould may comprise a housing adapted to receive the insert so as to control its position and prevent any movement during a flow of plastic material.

The invention also relates to a method for moulding a motor vehicle part made of plastic material comprising at least one partially overmoulded insert, wherein the following steps are performed using an assembly according to the invention of a mould and a device:
engaging the device in or on the insert;
introducing the insert in the mould;
pressing at least one sheet of plastic material on the device to pierce the sheet of plastic material using the piercing means;
closing the mould and applying pressure to make the plastic material flow;
opening the mould and ejecting the part carrying the overmoulded insert.

According to the invention, the device can be removed from the part.

Lastly, according to the invention, the device can be engaged in or on the insert by tight assembly, and pressure is applied when closing the mould to continue pressing on the device to provide a seal.

The invention will be better understood on reading the accompanying figures, which are given solely by way of example and not limiting in any way, in which:

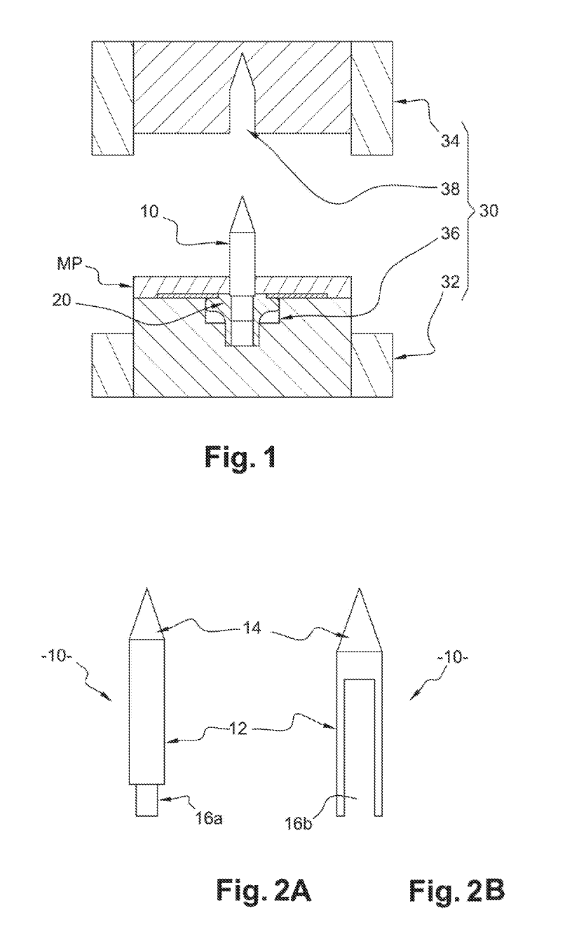

FIG. 1 schematically illustrates an embodiment of an assembly comprising a mould, a fastening insert, and a device for protecting the insert for its overmoulding;

FIGS. 2A and 2B illustrate in detail two embodiments of the device for overmoulding a fastening insert;

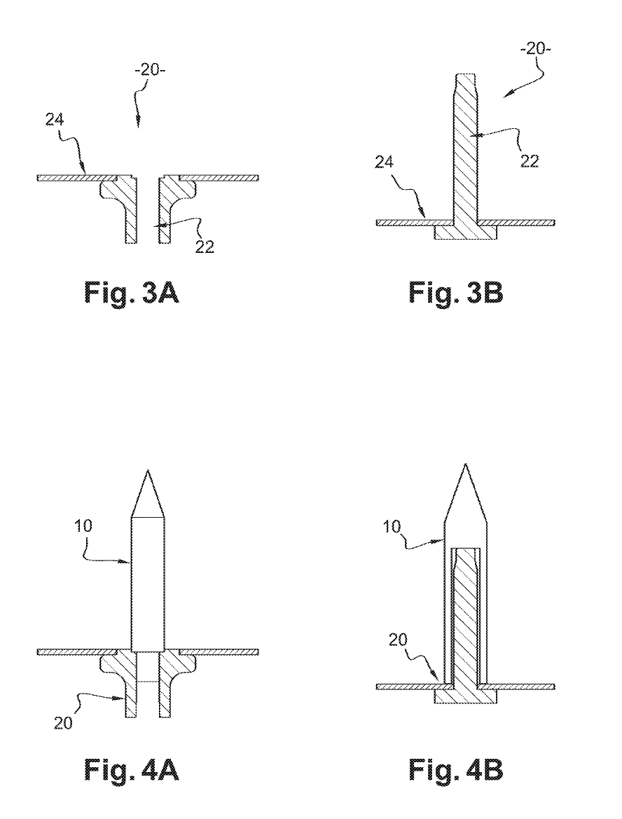

FIGS. 3A and 3B illustrate in detail two examples of a fastening insert, one with a tapped hole (FIG. 3A), the other with a screw (FIG. 3B);

FIGS. 4A and 4B illustrate in detail two examples of an assembly comprising a device inserted in or engaged on a fastening insert comprising a tapped hole (FIG. 4A) or a screw (FIG. 4B);

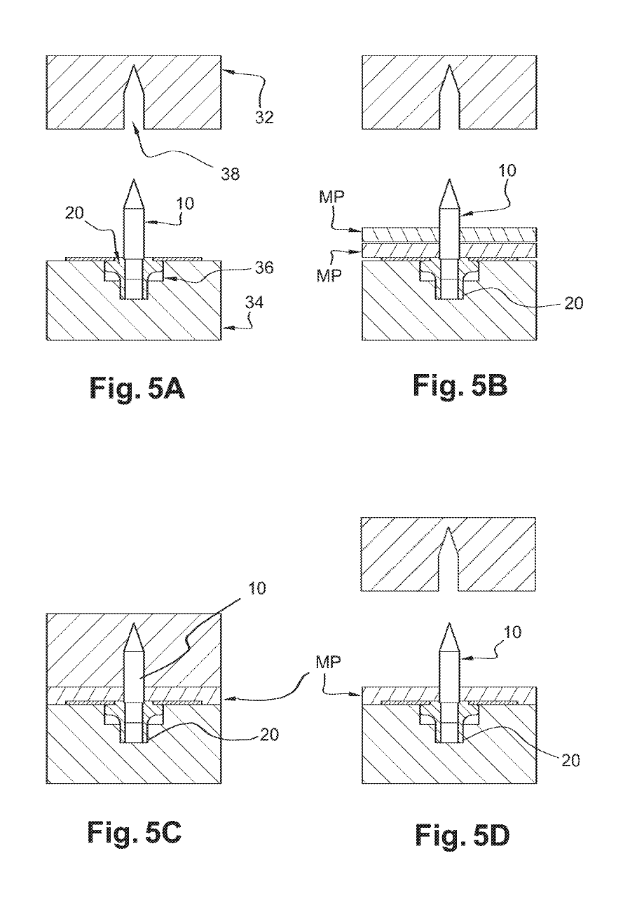

FIGS. 5A to 5D illustrate a method for moulding a motor vehicle part made of plastic material comprising a fastening insert, using a compression mould and a device for overmoulding the fastening insert;

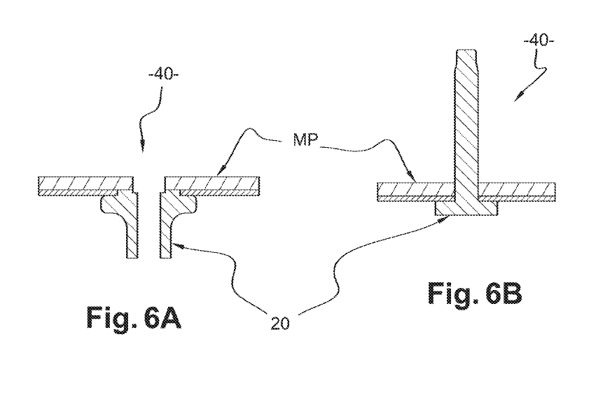

FIGS. 6A and 6B illustrate examples of parts obtained according to the method illustrated on FIGS. 5A to 5D.

We now refer to FIG. 1 which describes an embodiment of a device 10 for overmoulding a fastening insert 20, with a thermosetting plastic material MP using a compression mould 30. The mould 30 is thus used to form a motor vehicle part 40 (see FIGS. 6A and 6B) made of plastic material MP comprising at least one fastening insert 20.

The term “fastening insert” means a first element added to the mould cavity, during each moulding cycle, and comprising at least one fastening member. A fastening member is a functional interface area for fastening a second element to the part in which the insert is overmoulded. This fastening member can be a male or female thread carried by a screw or a tapped hole, a welding or bonding surface, a shape to be riveted, etc.

The device 10 can be used in particular to overmould a fastening insert 20 comprising a fastening member 22, since it protects this fastening member 22 by preventing, in the mould cavity, the plastic material MP from covering it, even partially, in order to preserve the optimum fastening functionality of the insert 20.

We now refer to FIGS. 2A and 2B, which illustrate in detail two embodiments of the device 10, wherein the fastening member 22 is a thread.

According to these two examples, the device 10 has an elongated outer shape, forming a main shaft 12 having two ends of different shape and function. According to the example illustrated, the shaft is cylindrical. The shaft cross-section may, however, have any shape: square, triangular, etc.

The first end is provided with piercing means 14, adapted to cross at least one sheet of semi-finished product made of thermosetting or thermoplastic material MP. This piercing means 14, of tapered shape and/or having edges can be attached to the shaft 12 or made in one piece with the shaft 12.

The second end, opposite the first end, is provided with means 16 for sealing the fastening member 22 to prevent infiltration of plastic material MP during the overmoulding operation. This sealing means 16 can be attached to the shaft 12 or made in one piece with the shaft 12.

The sealing means 16 prevents plastic material MP from flowing onto the fastening member 22 during the overmoulding operation.

Various solutions can be considered to perform this function. For example, the sealing means 16 can be designed according to the geometry of the fastening insert 20 and the fastening member 22, to obtain tight pre-assembly, providing sealing by clamping. This sealing can be increased by advantageously using the compression exerted by the moving part of the mould. Thus, when closing the mould, the device 10 can be pressed more strongly against the insert 20, to obtain a pressing area increased by a controlled additional deformation of the sealing means 16. The moving element of the mould then presses the device 10 on the insert 20, thereby providing a better seal during the moulding operation.

This solution can be replaced by or combined with other solutions. For example, the sealing means 16 may have shapes such as gadroons, ribs, beads, shoulders, pressing against the insert 20, during the pre-assembly and/or by pressing and additional deformation obtained when closing the mould, which then create an improved barrier preventing the passage of the plastic material MP.

The device 10 thus forms a “piercing plug”, adapted to cover at least locally an area of the insert to protect the fastening member 22 from being covered by material MP during moulding, and adapted to pierce sheets of semi-finished product made of thermosetting or thermoplastic plastic material.

The piercing means 14 for piercing and crossing a sheet of semi-finished product made of plastic material, such as a sheet of SMC, may have tapered shape and/or edges. Generally, those skilled in the art will be able to find the best shape for piercing the load (set of sheets of plastic materials) introduced into the mould 30, and required to manufacture the motor vehicle part 40.

This piercing means 14 is preferably made of a polyamide-based material.

The device 10 forms a sealing piercing plug, i.e. a member adapted to cooperate with a member of the insert 20 carrying the fastening member 22, to be interposed between the plastic material MP and the fastening member 22.

Thus, when the insert 20 comprises a tapped hole (FIG. 3A) carrying the thread 22a, and forming a female element, then the sealing means 16a comprises a male element (FIG. 2A) adapted to cooperate, by insertion for example, with this female element, in order to sealably plug the tapped hole. Thus, after engaging the device 10 in the insert 20, or more precisely the means 16a in the tapped hole, the device 10 is pressed tightly against the insert 20, forming a seal. FIG. 4A illustrates such an embodiment once the device 10 and the insert 20 have been assembled.

When the insert 20 comprises a screw (FIG. 3B) carrying the thread 22b, and forming a male element, then the sealing means 16b comprises a female element (FIG. 2B) adapted to cooperate, by insertion for example, with this male element, in order to sealably cover the screw. Thus, after engaging the device 10 on the insert 20, or more precisely the screw in the means 16b, the device 10 is pressed tightly against the insert 20, forming a seal. FIG. 4B illustrates such an embodiment once the device 10 and the insert 20 have been assembled.

When the insert is a weldable insert, i.e. when the insert 20 is adapted to be welded to a metal element of the vehicle, for example the body, then the sealing means 16 has a shape that is complementary to the area 22 to be welded of the insert 20.

The invention also relates to an assembly of an insert 20 and a device 10 as described previously. The device 10 is adapted to the insert 20, as illustrated by both FIGS. 4A and 4B.

According to one embodiment, in order to obtain a better seal, the device 10 comprises a thread cooperating with the thread 22 of the insert. The threads of the device 10 are configured such that after engaging the insert 20 and the device 10, the device 10 is pressed tightly against the insert 20, forming a seal.

The insert 20 can be made of any material, in particular metal or plastic materials.

The invention also relates to an assembly of a mould 30 and a device 10 as described previously.

The mould 30 is a compression mould to form a motor vehicle part 40 made of plastic material MP comprising at least one fastening insert 20.

The mould 30 can be used in particular to partially overmould the insert 20. Overmoulding is said to be partial when at least one surface of the insert remains visible after overmoulding: the surface is not covered with plastic material during overmoulding.

As illustrated on FIG. 1, the mould 30 comprises two moulding portions 32 and 34, defining the chamber for overmoulding the insert 20 and defining the mould cavity.

Preferably, the mould 30 comprises a housing 36 adapted to receive the insert 20 so as to control its position and prevent any movement of the insert 20 during the flow of plastic material.

According to one embodiment, one of the portions 32 and 34 comprises a housing 38 adapted to receive a portion of the device 10 comprising at least the piercing means 14. The piercing means 14 thus forms a male element adapted to cooperate by insertion with the housing 38 forming a female element, so that once the mould 30 is closed, and during the compression of the plastic material MP, the device 10 is partially engaged in the housing 38.

The dimensions and shapes of the housing 38 are defined so that, when the mould is closed, the portion 32 or 34 of the mould 30 carrying the housing 38 presses the device 10 to:
press the device 10 tightly on the insert 20, and therefore provide optimum sealing of the fastening member 22;
produce axial compression (i.e. in the mould closing direction) of the device 10 and thus axial crushing of the sealing means 16 or radial expansion against the housing 38, and therefore, prevent infiltration of plastic material MP into this housing 38.

The invention also relates to a method for moulding a motor vehicle part 40 made of plastic material comprising at least one partially overmoulded insert 20. FIGS. 4A and 4B illustrate the portion of such a part comprising the insert 20.

FIGS. 5A to 5D illustrate the method. Note that these figures do not represent the whole mould 30, but only the portion near the insert 20. In particular, we do not see the entire overmoulding cavity, and the contacts between the portions 32 and 34 of the mould 30.

According to this method, at least some of the following steps are performed using an assembly of a mould 30 and a device 10 according to the invention and using an assembly of an insert 20 and the same device 10:
a) engaging the device 10 in or on the insert 20, so as to protect the fastening member 22 from infiltration of plastic material MP (FIG. 5A);
b) introducing the insert 20 into the mould 30, and optionally positioning it in the housing 36 (FIG. 5A);
c) placing a loading plane, i.e. at least one sheet of semi-finished product made of plastic material, on the device 10 to pierce the sheet(s) of plastic material, using the piercing means 14 (FIG. 5B);
d) closing the mould 30, the device 10 partially engaging in the housing 38, and applying pressure (during compression or injection) to make the material MP flow in the mould cavity (FIG. 5C);
e) opening the mould 30 (FIG. 5D) and ejecting the part 40 carrying the overmoulded insert 20;
f) optionally, removing the device 10 from the part 40 (FIG. 5D).

FIGS. 6A and 6B illustrate examples of parts 40 obtained according to this method.

The device 10 can be reused. In this case, the method is restarted from step b) with the same device 10 to produce another part.

1. Device for protecting a fastening insert to overmould the fastening insert with a plastic material using a mould the fastening insert having a fastening member, wherein the device comprises:
piercing means adapted to pierce at least one sheet of plastic material;
means for sealing the fastening member to prevent infiltration of plastic material on the fastening member during an overmoulding operation.

2. Device according to claim 1, forming a shaft comprising first and second ends opposite each other, the first end being provided with said piercing means, and the second end being provided with at least one portion of the sealing means.

3. Device according to claim 1, wherein the piercing means has a tapered shape and/or edges.

4. Device according to claim 1, wherein the sealing means forms a plug.

5. Device according to claim 1, wherein the sealing means is adapted to be tightly assembled on an insert.

6. Device according to claim 1, wherein the sealing means comprises shapes creating a barrier to the passage of the plastic material.

7. Device according to claim 1, wherein the fastening member is a thread.

8. Device according to claim 7, wherein the sealing means comprises a thread cooperating with the thread of the insert.

9. Assembly of an insert and a device according to claim 1, wherein the insert comprises a tapped hole having a thread and forming a female element, and the sealing means comprises a male element adapted to cooperate with the female element in order to sealably plug the tapped hole.

10. Assembly of an insert and a device according to claim 1, wherein the insert comprises a screw having a thread and forming a male element, and the sealing means comprises a female element adapted to cooperate with the male element in order to sealably cover the screw.

11. Assembly of an insert and a device according to claim 9, wherein the sealing means is tightly assembled on the insert.

12. Assembly of a mould and a device according to claim 1, wherein the mould comprises a housing adapted to receive a portion of the device comprising at least the piercing means.

13. Assembly according to claim 12, wherein the dimensions of the housing are defined so that when the mould is closed, a portion of the mould presses on the device so as to press the device tightly on the insert and so as to crush the device in order to fill the housing to prevent an infiltration of plastic material in the housing.

14. Assembly according to claim 12, wherein the mould comprises a housing adapted to receive the insert so as to control its position and prevent any movement during a flow of plastic material.

15. Method for moulding a motor vehicle part made of plastic material comprising at least one partially overmoulded insert, wherein the following steps are performed using an assembly according to claims 12:
engaging the device in or on the insert;
introducing the insert in the mould;
pressing at least one sheet of plastic material on the device to pierce the sheet of plastic material using the piercing means;
closing the mould and applying pressure to make the plastic material flow;
opening the mould and ejecting the part carrying the overmoulded insert.

16. Method according to claim 15, wherein the device is removed from the part.

17. Method according to claim 15, wherein the device is engaged in or on the insert by tight assembly, and pressure is applied when closing the mould to continue pressing on the device to provide a seal.
